(19) United States
(12) Patent Application Publication
(10) Pub. No.: US 2026/0316454 A1
(43) Pub. Date: Oct. 15, 2026

(54) CARTRIDGE FOR STABLE HIGH-OUTPUT AEROSOL-BASED PRINTING

(71) Applicant: Integrated Deposition Solutions, Inc., Albuquerque, NM (US)

(72) Inventors: Marcelino Essien, Albuquerque, NM (US); David M. Keicher, Albuquerque, NM (US)

(73) Assignee: Integrated Deposition Solutions, Inc., Albuquerque, NM (US)

(21) Appl. No.: 19/491,475

(22) PCT Filed: Jun. 18, 2024
(86) PCT No.: PCT/US2024/034422

§ 371 Date: Dec. 9, 2025

Related U.S. Application Data
(60) Provisional application No. 63/472,829, filed on Jun. 14, 2023.

(51) Int. Cl. B41J 2/175

(52) U.S. Cl. CPC B41J 2/17513; B41J 2/17556

(57) ABSTRACT

An aerosol printing cartridge for producing a dense, stable aerosol output and a method of printing high-resolution features. The cartridge includes a housing defining an internal volume, a baffle positioned Within the internal volume of the housing, an inlet tube, an outlet port, and a vial releasably connected to a bottom end of the housing and in fluid communication With the internal volume of the housing, the vial configured to store a liquid sample. The baffle divides the internal volume into three partially isolated regions including a first region, a second region, and a third region. The inlet tube has a first end positioned, outside the housing and a second, end positioned Within in second region of the internal volume of the housing. The outlet port extends through the housing and fluidly connects the third region of the internal volume of the housing to outside the housing.

### RELATED APPLICATIONS

This application claims priority benefit of U.S. Provisional Application Ser. No. 63/472,829 filed 14 Jun. 2023; the contents of which are hereby incorporated by reference.

### FIELD OF THE INVENTION

The present invention in general relates to aerosol printing, and in particular to devices that aerosolize a liquid to produce a dense, stable distribution of aerosol droplets for use in aerosol-based printing to deposit high-density, high-resolution traces on a surface.

### BACKGROUND OF THE INVENTION

Direct Write printing, defined as maskless printing of discreet patterns on a substrate in a one-step process offers many advantages to conventional printing technologies such as lithography and chemical and physical vapor deposition. Indeed, Direct Write processes such as aerosol-based printing are far less expensive to establish and maintain and offer greater flexibility than conventional techniques.

Aerosol-based printing generally uses an aerosol cartridge, which is an enclosure used to contain a liquid sample that is aerosolized to form buoyant droplets that are expelled from the enclosure. Aerosol generators commonly use compressed gas, a propellant, or vibrational or rotational energy to generate aerosols. Generally, a pneumatically sealed cartridge is placed in communication with an aerosol source, and a carrier gas is used in combination with a valve to expel the aerosol from the cartridge.

More specifically, aerosolization is a process in which energy is imparted to a bulk liquid, causing the liquid to be sheared into filaments that break into buoyant droplets. In pneumatic aerosolization, a stream of liquid is drawn into the channel of a tube with one end immersed in a reservoir of the liquid. A rapidly flowing gas is directed across the open end of the tube, so that the liquid is drawn through the tube, emerges at the open end of the rod, and undergoes a shearing force that produces droplets. In ultrasonic aerosolization a piezoelectric crystal is used to produce vibrations at a liquid surface that produce buoyant droplets. In either case, the aerosolization process can produce aerosols or non-buoyant droplets with random trajectories and kinetic energies that preclude the formation of an aerosol cloud with a constant and spatially uniform distribution. Indeed, in ultrasonic aerosolization, a liquid spout is produced that randomly displaces buoyant droplets, causing spatial and temporal variations in the aerosol density.

In ultrasonic aerosolization, an ultrasonic atomizer is used to produce aerosol droplets. In aerosol printing applications, aerosol droplets with diameters ranging from approximately 0.5 to 5 microns are produced by various aerosolization methods. Ultrasonic aerosolization produces a droplet diameter distribution that requires a series of aerodynamic lenses for optimal focusing. Generally, in ultrasonic aerosolization, a 1.6 MHz transducer produces droplets with a median diameter of approximately 3 microns. Droplets with diameters as small as 0.5 and as large as 5 microns can be produced using a 1.6 MHz transducer frequency, so that a multi-lens aerodynamic focusing assembly is needed to perform high-definition aerosol printing.

Pneumatic aerosolization produces droplets in a size range similar to that of ultrasonic aerosolization, but in general, can aerosolize liquids with higher viscosities. Pneumatic aerosolization is a viable method of producing an aerosol cloud and is best used with liquid samples with low vapor pressure. Liquid samples with volatile components such as alcohols can be degraded by the high-velocity gas flows that the pneumatic process requires. Ink degradation in pneumatic aerosolization can be reduced by reducing the operating temperature and by increasing the vapor content of the volatile component in the atomizing gas flow.

Other aerosolization methods can be used to produce a stable aerosol output that can be transported from the aerosol cartridge. Alternative aerosolization methods include filament extension atomization, vibrating mesh atomization, and electrospray atomization.

In Filament Extension Atomization (FEA) an ink is flowed between two smooth counter-rotating surfaces, creating a filament that is stretched until breakup occurs. Other embodiments of FEA are also applicable to aerosol-based printing. The resulting aerosol can be nearly monodispersed and can be transported to a flow cell and focused for use in aerosol jet printing applications. The FEA process can be tuned to provide the optimum droplet size distribution for a specific aerodynamic lens assembly, or for a single aerodynamic lens.

In electrospray atomization, an electric field is used to pull droplets from a fluid meniscus formed between a nozzle with a pendant emerging fluid and a charging plate. A relatively narrow droplet diameter is produced in the electrospray aerosolization technique so that tight focusing of an aerosol can be accomplished using two aerodynamic lenses. An ionization source is typically used to remove charge from the droplets prior to the focusing step.

In vibrating mesh aerosolization, a liquid sample is placed above a mesh composed of small holes. A piezoelectric element forces the mesh to vibrate vertically, so that fluid is entrained and emitted from the mesh. Vibrating mesh aerosolization can produce an aerosol distribution with a relatively small diameter dispersion. Vibrating mesh nebulizers produce droplets with diameters in the range of approximately 1 to 5 microns.

A drawback of existing aerosolization methods is that these methods produce pressure fluctuations within the cartridge that result in non-constant temporal and spatial aerosol density that disrupt the flow of ink and create errors and gaps in the application of the ink on the substrate.

Thus, there exists a need for a device capable of producing a dense, stable distribution of aerosol droplets for use in aerosol-based printing to deposit high-density, high-resolution traces on a surface of a substrate.

### SUMMARY OF THE PRESENT INVENTION

The present invention provides an aerosol printing cartridge for production of a dense, stable aerosol output. The cartridge includes a housing having a height and a width and defining an internal volume, a baffle positioned within the internal volume of the housing, an inlet tube, an outlet port, and a vial releasably connected to a bottom end of the housing and in fluid communication with the internal volume of the housing, the vial configured to store a liquid sample. The baffle divides the internal volume into three partially isolated regions including a first region, a second region, and a third region. The inlet tube has a first end positioned outside the housing and a second end positioned within in second region of the internal volume of the housing. The outlet port extends through the housing and fluidly connects the third region of the internal volume of the housing to outside the housing. The cartridge is capable of producing a dense, stable distribution of aerosol droplets for use in aerosol-based printing to deposit high-density, high-resolution traces on a surface of a substrate.

The present invention also provides a method of printing discrete high-resolution high-density features on a surface using an aerosol stream. The method includes producing an aerosol-laden transport gas having aerosol droplets and a sheath gas surrounding the aerosol-laden transport gas in a cartridge as described above at a voltage of 30 to 35.1 Volts and exhausting the aerosol-laden transport gas onto the substrate or a plurality of substrates.

### BRIEF DESCRIPTION OF THE DRAWINGS

The present invention is further detailed with respect to the following figures that depict various aspects of the present invention.

FIG. 1 is a perspective view of an aerosol printing cartridge for production of a dense, stable aerosol output according to embodiments of the present invention;

FIG. 2 is a cross-sectional view of an aerosol printing cartridge for production of a dense, stable aerosol output according to embodiments of the present invention;

FIG. 3A is a bottom cross-sectional view of an aerosol printing cartridge for production of a dense, stable aerosol output having an L-shaped baffle according to embodiments of the present invention;

FIG. 3B is a bottom cross-sectional view of an aerosol printing cartridge for production of a dense, stable aerosol output having an cylindrical baffle according to embodiments of the present invention;

FIG. 3C is a bottom cross-sectional view of an aerosol printing cartridge for production of a dense, stable aerosol output having an C-shaped baffle according to embodiments of the present invention;

FIG. 4A is a bottom cross-sectional view of the aerosol printing cartridge of FIG. 3A with an arrow showing the flow of carrier gas; and

FIG. 4B is a bottom cross-sectional view of the aerosol printing cartridge of FIG. 3B with an arrow showing the flow of carrier gas.

### DESCRIPTION OF THE INVENTION

The present invention has utility as an aerosol cartridge capable of producing a dense, stable distribution of aerosol droplets for use in aerosol-based printing to deposit high-density, high-resolution traces on a surface of a substrate. According to embodiments, the aerosol cartridge isolates an aerosol chamber from carrier gas input and aerosol output ports, minimizing or eliminating pressure fluctuations and fluid entrainment in the ports, to produce a dense, stable aerosol output.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, the inventive aerosol cartridge isolates an aerosol chamber from carrier gas input and aerosol output ports, minimizing or eliminating pressure fluctuations and fluid entrainment in the ports, to produce a dense, stable aerosol output. The production of a dense, stable aerosol is critical to production of a stable aerosol output. In the optimal case, the aerosol density in an aerosol cartridge is saturated, so that small changes in the production of droplets do not affect the temporal or spatial distribution of aerosol. In the case of ultrasonic aerosolization, a constant temporal and spatial aerosol density is most easily achieved when an energetic liquid spout is produced in the cartridge. Energetic spouts, however, produce significant pressure fluctuations, as large droplets with random trajectories propagate throughout the aerosol chamber of the cartridge. The present invention partially or completely suppresses pressure fluctuations caused by an energetic liquid spout produced by ultrasonic aerosolization. The present invention also suppresses pressure fluctuations produced by other aerosolization methods, so that a dense, stable aerosol output is achieved.

The present invention produces a stable output aerosol stream by forming three connected chambers within the cartridge that allow for the production or introduction of aerosol in a first inner aerosol chamber, and the flow of a carrier gas from a second chamber across the first chamber and to a third outlet chamber. The second and third chambers are buffered from pressure fluctuations and random droplet impacts that occur in the first chamber. These three connected volumes allow for the production and transport of a dense, stable aerosol cloud, without entrainment of liquid in the gas input or aerosol out ports of the cartridge.

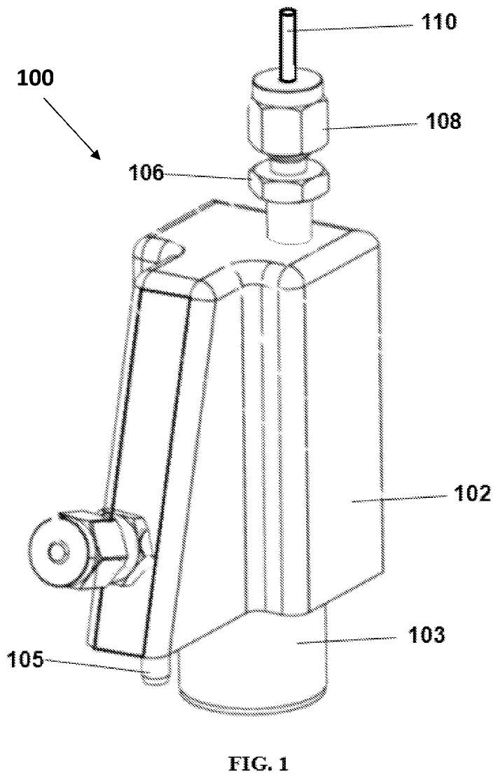

As shown in FIG. 1, embodiments of the inventive cartridge 100 include a cartridge housing 102 that defines an internal volume 104. A carrier gas tube 110 extends from outside the cartridge housing 102 into the internal volume 104 within the cartridge housing 102. A first 112 end of the carrier gas tube 110 positioned outside the cartridge housing 102 is configured to be fluidly connected to a carrier gas source (not shown) and a second end 114 of the carrier gas tube 110 positioned in the internal volume 104 within the cartridge housing 102. According to embodiments, the carrier gas tube 110 extends through an upper wall 107 of the cartridge housing 102. According to embodiments, the height of the carrier gas tube 110 can be adjusted by loosening a nut 106 of a pneumatic fitting 108. According to embodiments, the carrier gas tube 110 includes holes in the side of the tube so that the carrier gas is diffused as it enters the internal volume 104 of the cartridge 100. According to embodiments, the nut 106 also acts as a choke that tightens or loosens around the carrier gas tube 110 to adjust the flow dynamics of the input carrier gas.

Embodiments of the inventive cartridge 100 additionally include a liquid sample vial 103 positioned at the bottom end of the cartridge housing 102. An ultrasonic atomizer (not shown) is used to produce a dense aerosol in the liquid sample vial 103. The cartridge 100 additionally includes an outlet port 105 positioned on a bottom end of the cartridge housing 102 through which an aerosol stream is output from the cartridge 100.

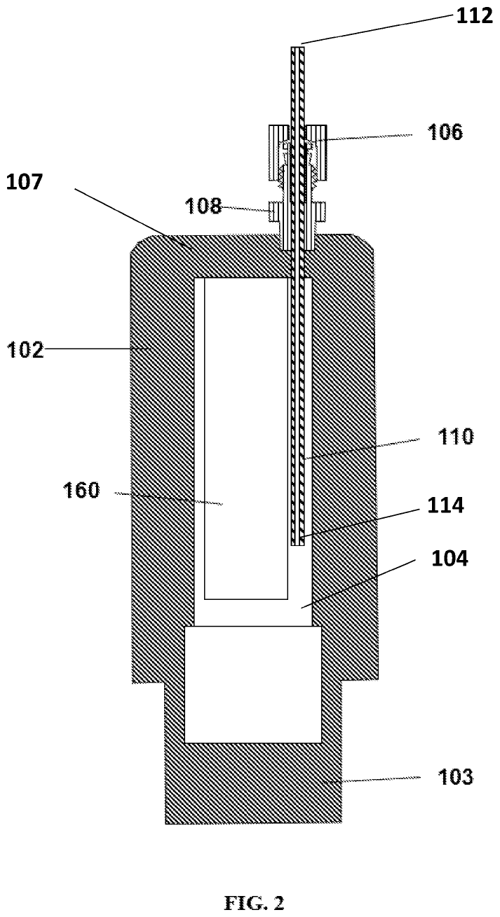

As shown in FIG. 2, embodiments of the inventive cartridge 100 additionally include a baffle 160 positioned within the internal volume 104 within the cartridge housing 102. The baffle 160 is configured to divide the internal volume 104 within the cartridge housing 102 into three partially isolated regions 130, 140, 150. Notably, a first region 140 is generally centrally located within the internal volume 104 and is generally the largest of the three regions. A second region 130 contains the second end 114 of the carrier gas tube 110 positioned in the internal volume 104 within the cartridge housing 102. A third region 150 isolates the outlet port 105 from the first region 140. The baffle 160 isolates the aerosol gas tube and the outlet port 105 from the liquid spout produced in the ultrasonic aerosolization process.

In use, an ultrasonic atomizer (not shown) is used to produce a dense aerosol in the liquid sample vial 103. An aerosol cloud expands into and fills the first region 140 of the internal volume 104 of the cartridge 100. A dry or vapor-laden carrier gas enters the cartridge 100 through carrier gas tube 110 located in the second isolated region 130. The downwards facing orientation of the carrier gas tube 110 forces gas to flow from the second end 114 thereof past the bottom of a baffle 160 and across the surface of the sample in the sample vial 103, so that aerosol is entrained in the gas flow and then into the first isolated region 140. An aerosol-laden carrier gas then enters the third region 150 and exits the central region through an exit channel (not shown). The aerosol-laden flow propagates along the exit channel and exits the cartridge 100 at outlet port 105.

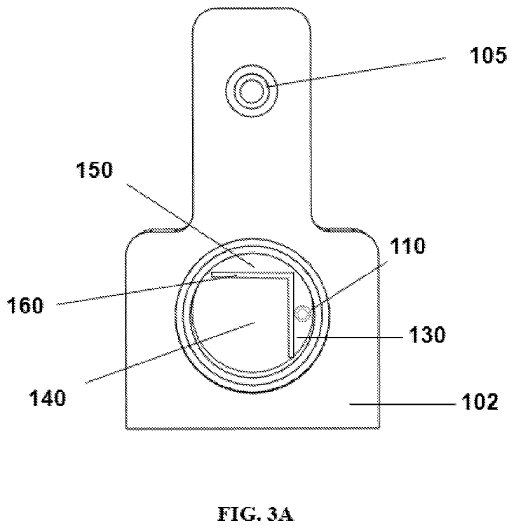

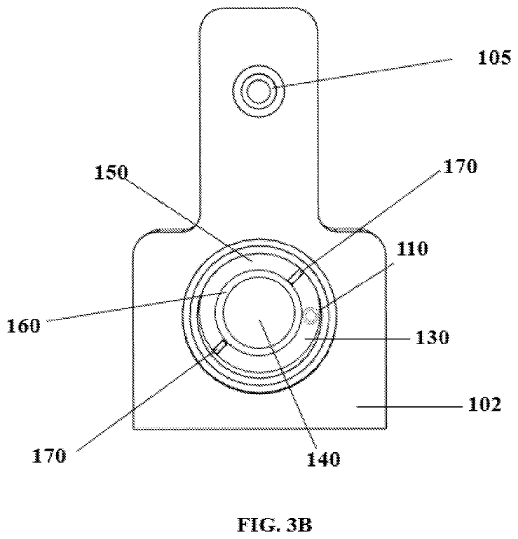

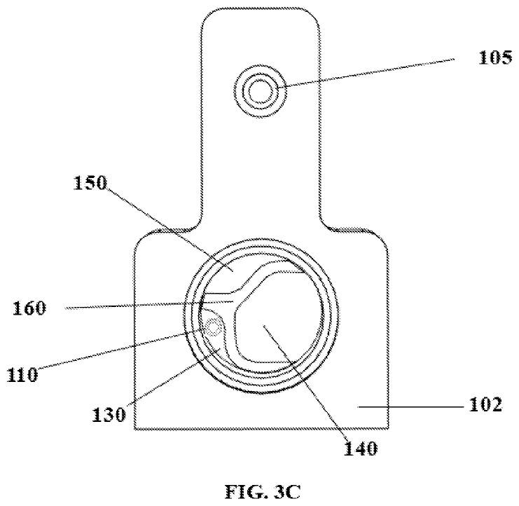

According to embodiments, pressure fluctuations that occur within the central region 140 that would otherwise cause variations in the aerosol density and aerosol output are partially or completely suppressed in isolated regions 130 and 150 given the presence of the baffle 160. In the embodiment shown in FIG. 3A, the baffle 160 is L-shaped and extends from the top of the cartridge to a few millimeters above the liquid sample surface within the sample vial 103. The baffle 160 suppresses pressure fluctuations from region 140 so that the standard deviation of the aerosol volumetric flow rate from the cartridge is less than 5% of the average volumetric flow rate over a period of at least twenty-four hours. The baffle 160 also minimizes or eliminates fluid entrainment into the carrier gas tube 110 located in the second region 130 or into the aerosol output port 105 located in the region 150. The minimization or elimination of pressure fluctuations and fluid entrainment provided by the invention allows for increased energy input into the cartridge for aerosolization. The resulting increase in aerosolization in turn produces a more spatially and temporally uniform aerosol cloud and increases the output of the aerosol cartridge 100.

According to embodiments, various baffle 160 designs are utilized to form the partially isolated regions 130, 140, 150 in the cartridge and produce sufficient suppression of pressure fluctuations so that a stable aerosol output is achieved. Two additional embodiments of the invention are shown in FIGS. 3B and 3C. In each configuration, a baffle 160 forms the partially isolated regions 130, 140, and 150, while a carrier gas input tube 110 is located between the outer wall of the baffle 160 and the inner wall of the cartridge 100 that defined the internal volume 104 of the cartridge 100. In the embodiment of FIG. 3B, a cylindrical baffle 160 and two ribs 170 span the length of the cartridge 100 and form regions 130, 140, and 150. A carrier gas flows from carrier gas tube 110 and into the second region 130. The ribs 170 force the carrier gas to flow downward into the sample vial 103, across the aerosol-dense first region 140, and into the third region 150, so that a dense, stable aerosol-laden flow exits the cartridge at outlet port 105.

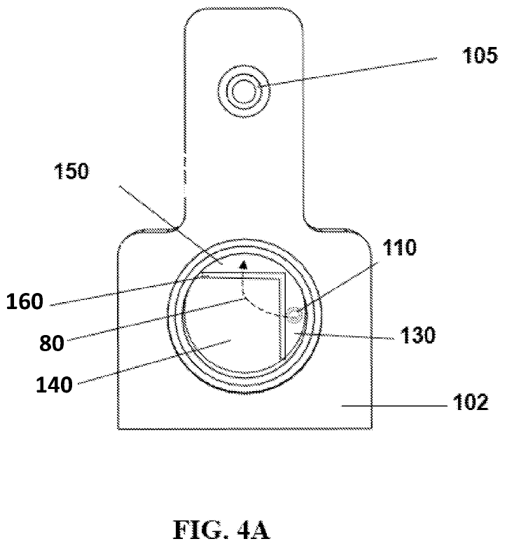

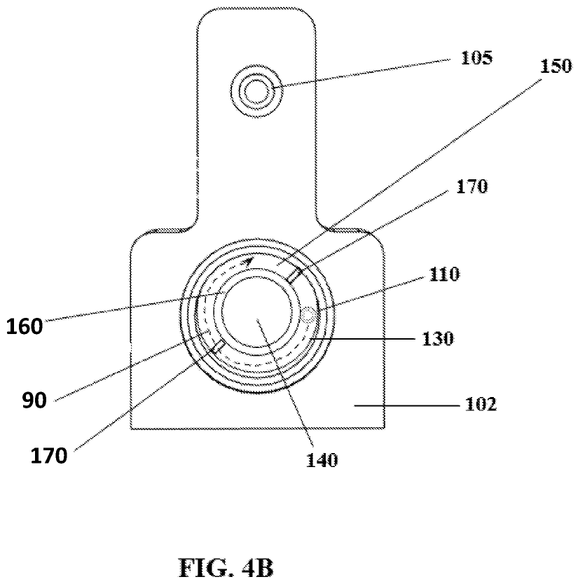

FIG. 4A shows an embodiment of the invention where the carrier gas flow 80 propagates from the carrier gas tube 110, across the first region 140, and into the third region 150, before exiting the cartridge 100 via the outlet port 105. In FIG. 4B, the carrier gas flow 90 propagates around the cylindrical baffle 160 entirely in the second isolated region 130. The most stable aerosol output is achieved in the configuration of FIG. 4B, while the greatest aerosol entrainment is achieved in the case of the carrier gas flow path shown in FIG. 4A.

Embodiments of the present invention provide several advantages over existing aerosol-based printing cartridges. For example, the efficacy of the carrier gas entrainment and transport of aerosol droplets is increased given that the carrier gas is introduced in a downwards flowing orientation. Swirling and stagnation of the gas flow is minimized with a downwards flow. In a downwards flowing configuration, droplets are efficiently entrained in the carrier gas flow, transported under a baffle 160 or series of baffles, and transported from the cartridge 100. According to embodiments, the downward flow of the carrier gar is provided as a vortex. Additionally, embodiments of the present invention reduce the time that an entrained droplet spends in the aerosol chamber (first region 140), so that droplet solvent evaporation is minimized. Minimization of solvent evaporation is critical for maintaining a droplet diameter distribution that is matched to an aerodynamic lens assembly. Furthermore, embodiments of the present invention allow the aerosol chamber voltage to be increased 20-30% from the typical 25-27 volts. A more stable ink spray results that manifests as longer continuous run times, such as 4 or more hours.

According to embodiments, the dimensional requirements of the cartridge 100 are dictated by the physics of the aerosolization process. The internal volume 104 is sufficiently large to prevent impingement of the fluid spout of carrier gas formed in the ultrasonic aerosolization process. Impingement of the fluid spout of carrier gas directly onto the dense aerosol in the liquid sample vial 103 can suppress aerosolization and lead to heating and unstable aerosol production. For example, in the case of ultrasonic aerosolization, the aerosol chamber must be large enough to preclude suppression of the liquid spout produced by an ultrasonic transducer. The minimum width and depth of an ultrasonic aerosol cartridge is approximately 15 mm, with a height of approximately 70 mm. A cartridge design with sufficiently large dimensions will also allow for an efficient baffle design, so that distinct aerosolization, gas input, and aerosol output regions are formed within the cartridge chamber.

According to embodiments, the present invention is used for aerosol-based printing. In aerosol printing the output of an aerosol cartridge is first delivered to an aerosol flow cell. An aerosol flow cell is a device used to focus and collimate an aerosol stream composed of a monodisperse or polydisperse distribution of droplets. The flow cell can use aerodynamic focusing, where droplets are propagated through a single aerodynamic lens, or through a series of aerodynamic lenses, to produce a stable aerosol jet. The aerosol cartridge output can also be propagated through a sheathed flow cell configuration that combines aerodynamic focusing and hydrodynamic focusing through a single aerodynamic lens or through a series of aerodynamic lenses. The aerosol jet is then directed onto a substrate to produce continuous films or discreet structures with line widths ranging from approximately 5 to 200 microns. According to embodiments, the stable aerosol stream that is output from the cartridge 100 is propagated through an aerodynamic lens assembly or a sheathed aerodynamic lens assembly to form a stable aerosol jet. A common aerosol jet application is non-contact printing of continuous films or discreet structures.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. An aerosol printing cartridge for production of a dense, stable aerosol output, the cartridge comprising:
a housing having a height and a width and defining an internal volume;
a baffle positioned within the internal volume of the housing, the baffle dividing the internal volume into three partially isolated regions including a first region, a second region, and a third region;
an inlet tube having a first end positioned outside the housing and a second end positioned within in second region of the internal volume of the housing;
an outlet port extending through the housing and fluidly connecting the third region of the internal volume of the housing to outside the housing; and
a vial releasably connected to a bottom end of the housing and in fluid communication with the internal volume of the housing, the vial configured to store a liquid sample.

2. The cartridge of claim 1 wherein the height of the housing from the bottom end of the housing to a top end of the housing of 60 to 80 mm.

3. The cartridge of claim 1 wherein the width of the housing from a first sidewall of the housing to a second sidewall of the housing of 10 to 20 mm.

4. The cartridge of claim 1 wherein the internal volume has a height that is one 50 to 90 percent of the height of the housing.

5. The cartridge of claim 1 wherein the baffle is one of L-shaped or cylindrical.

6. The cartridge of claim 1 wherein the baffle abuts an upper end of the internal volume of the housing.

7. The cartridge of claim 1 wherein the baffle extends from an interior wall of the housing.

8. The cartridge of claim 1 wherein the baffle further comprises a set of ribs projecting outward from the baffle and abutting sidewalls of the internal volume of the housing.

9. The cartridge of claim 1 wherein a lower edge of the baffle is spaced apart from the vial.

10. The cartridge of claim 1 wherein the first region of the internal volume of the housing is larger than the second region and the third region.

11. The cartridge of claim 1 wherein the baffle is interchangeable.

12. The cartridge of claim 1 wherein a position of the second end of the inlet tube is adjustable relative to a bottom edge of the baffle.

13. The cartridge of claim 1 wherein the first end of the input tube is configured to be fluidly connected to a carrier gas source.

14. The cartridge of claim 1 wherein the vial is configured to be fluidly connected to an ultrasonic atomizer to produce a dense aerosol in the vial.

15. The cartridge of claim 1 wherein the cartridge is capable of delivering a stable volumetric flow rate for 24 hours or more with a coefficient of variation of 5% or less and where the cartridge is capable of delivering a continuous run time of at least 4 hours.

16. The cartridge of claim 1 wherein the second region and the third region are shielded from pressure fluctuations that occur in the first region of the internal volume of the housing.

17. A method of printing discrete high-resolution high-density features on a surface using an aerosol stream, the method comprising:
producing an aerosol-laden transport gas having aerosol droplets and a sheath gas surrounding the aerosol-laden transport gas in a cartridge of claim 1 at a voltage of 30 to 35.1 Volts; and
exhausting the aerosol-laden transport gas onto the substrate or a plurality of substrates.

18. The method of claim 17 wherein exhausting continues uninterrupted for at least 4 hours.

19. The method of claim 17 wherein the aerosol droplets have a mean diameter of between 0.5 and 5 microns.

20. The method of claim 17 wherein the resolution of printing is 5 micron lines or greater separated by 5 micron or greater gaps.
